(19) United States
(12) Patent Application Publication
(10) Pub. No.: US 2019/0142215 A1
(43) Pub. Date: May 16, 2019

(54) RADIANT/CONVECTION COOKING DEVICE

(71) Applicants: Ronald M. POPEIL, Beverly Hills, CA (US); Alan L. BACKUS, Los Angeles, CA (US)

(72) Inventors: Ronald M. POPEIL, Beverly Hills, CA (US); Alan L. BACKUS, Los Angeles, CA (US)

(21) Appl. No.: 15/862,175

(22) Filed: Jan. 4, 2018

Related U.S. Application Data
(60) Provisional application No. 62/584,374, filed on Nov. 10, 2017.

(51) Int. Cl. A47J 37/04

(52) U.S. Cl. CPC A47J 37/041

(57) ABSTRACT

Modular shelving systems for mounting foods within a food preparation environment, including mounting multiple levels of stacked shelves, and mounting inclined shelves which may be advantageous in cooking fowl and other tapered food articles. Radiant energy and moving hot air oven embodiments with efficient adjustable volume cooking cavities, economical construction details, and reduced volume storage. Manually powered spit food mounting embodiments, utilizing horizontal and inclined spit rods to facilitate, among other things, cooking of tapered food articles, such as, by way of non-limiting and non-exhausted examples, fowl and leg of lamb. Powered spit food mounting embodiments utilizing horizontal and inclined rods. Modular cooking cavity extensions which expand to meet cooking requirements. Safety interlocking switching features, which also make embodiment use more versatile. Vertical axis horizontal turntable.

### CROSS-REFERENCE TO RELATED APPLICATIONS

This application claims the benefit of U.S. Provisional Application No. 62/584,374, filed Nov. 10, 2017, which is incorporated herein by reference.

### TECHNICAL FIELD

The present application is directed to devices which cook foods utilizing radiant heat and hot air movement.

### BACKGROUND

Household countertop radiant/convection ovens which utilize hot air movement and radiant heat to cook foods are in common use today.

Among these devices are ovens which are generally cylindrical in design, with a base containing a removable drip pan, with one or more wire shelves removably mounted above the drip pan, and a clear cake cover type dome, having a utility box generally centrally externally mounted on the dome's upper surface. This utility box typically contains a motor driven fan, a rod-type radiant heating element mounted directly below the fan, and a control circuit which controls cooking time and temperature.

Also common on these devices are metal or plastic sidewall extension rings which elevate the clear cake cover type domes and thus extend the height and volume of the devices' cooking chambers.

These devices generally range in size from about 12 to 14 inches in diameter, and 9 to 12 inches in height without using extension rings or extended depth cake cover type domes.

Their fans generally utilize radial centrifugal straight vein fan blades, which are about 4 to 6 inches in diameter, with zigzag resistive electric rod-type heating elements, measuring also around 5×5″ disposed directly below the fan blades.

These devices are designed to cook a wide variety of foods, including: baked goods, such as cookies and cupcakes; vegetables; cuts of meat; fish; and small and large fowl, up to and including about a 16 pound turkey.

These devices have many advantages when compared to conventional household ovens, including: small size, the ability to easily watch foods as they cook, quick warm-up, significantly reduced cooking times, convenient countertop high cooking, the ability to brown and color foods, reduced electrical consumption, compact storage, and relatively easy cleanup,

These devices also are generally: easy and inexpensive to construct, relatively small to ship and store, and are lightweight and easy to handle.

In general, these devices provide a high quality of cooking, with foods coming out with good presentation, texture, juiciness, and flavorfullness.

However, these devices also have some noted disadvantages. One of these is that fowl, and in particular larger fowl, tend to be browned unevenly, due to the devices' relatively small rod type heating elements, which are disposed relatively close to the middle upper surfaces of foods being cooked. Regarding such large fowl, part of this is exacerbated by the fact that when such large, or even smaller fowl, are placed on a level wire shelf, the backs and/or bellies of the fowl tend to be inclined, with one end of the fowl being elevated closer to the heating element than the opposite end.

Another disadvantage these devices have is that their cylindrical shape is inefficient. As an example a 14 inch in diameter round wire shelf has a surface area of about 154 in.², where as a 14 in. square wire shelf has a surface area of 196 in.², or about 27% more surface area.

Yet another disadvantage these devices have is that they generally take up the same amount of space whether they are in use or they are being stored.

Yet another disadvantage these devices have is that they rely on difficult to clean wire shelves to support foods being cooked.

Embodiments herein address some or all these disadvantages.

### BRIEF DESCRIPTION OF THE DRAWINGS

FIG. 1 is a perspective of wire shelf 100 in its high position use condition.

FIG. 2 is a perspective of wire shelf 100 shown in FIG. 1, except wire shelf 100 is shown in its lower elevation use condition for, as non-exhaustive and non-limiting examples, low elevation cooking and compacted storage.

FIG. 3 is a perspective of wire shelf 100 shown in FIG. 1 with support leg 102 folded inward, causing wire platform 104 to be inclined.

FIG. 4 is a perspective of 3 wire shelves 100, with the three shelves being stacked one on top of the other.

FIG. 5 is a frontal view of the wire shelf 100 shown in FIG. 1.

FIG. 6 is a frontal view of the wire shelf 100 shown in FIG. 2.

FIG. 7 is a frontal view of the wire shelf 100 shown in FIG. 3.

FIG. 8 is a frontal view of the wire shelves 100 shown in FIG. 4.

FIG. 9 is a perspective taken from below, of the wire shelf 100 shown in FIG. 1, with support leg 106 partially exploded, and support leg 102 in both its high position use condition 108 and its storage or low position use condition 110.

FIG. 10 is a perspective of embodiment 112.

FIG. 11 is a wireframe perspective of embodiment 112.

FIG. 12 is a perspective exploded view of embodiment 112.

FIG. 13 is a perspective of embodiment 112 in its compacted storage condition.

FIG. 14 is a perspective of embodiment 112 without extension ring 124 in place. Upper translucent sidewalls 126 are placed directly on base 128.

FIG. 15 is a frontal view of the partially folded wire shelf 100 shown in FIG. 3, stacked on top of fully unfolded wire shelf 100 shown in FIG. 1, with food 134, a fowl, resting on its back on top, with the fowl's belly leveled by the inclined shelf it's resting upon.

FIG. 16 is a section perspective view of FIG. 13, as indicated in FIG. 13.

FIG. 17 is a perspective view of embodiment 136 in its use condition.

FIG. 18 is an exploded perspective view of FIG. 17.

FIG. 19 is a wireframe perspective view of embodiment 138.

FIG. 20 is a wireframe section taken through FIG. 19, as indicated in FIG. 19, with fowl 143 rotated to its belly up position.

FIG. 21 is a wireframe section taken through FIG. 19, as indicated in FIG. 19, with fowl 143 rotated to its belly down position.

FIG. 22 is a perspective view of embodiment 138.

FIG. 23 is an exploded perspective view of embodiment 138.

FIG. 24 shows an enlarged view portion of FIG. 23 as indicated in FIG. 23.

FIG. 25 is a perspective view of embodiment 170.

FIG. 26 is a wireframe view of FIG. 25.

FIG. 27 is an exploded perspective view of embodiment 170.

FIG. 28 is an exploded perspective view of embodiment 170, taken from below.

FIG. 29 is a perspective view of embodiment 170, with portions ghosted in dotted lines.

FIG. 30 is a perspective view of embodiment 170 being assembled.

FIG. 31 is a perspective of spit support platform 193 in both its operating (dotted lines) and its compacted condition (solid lines), for, as non-limiting and non-exhaustive examples, storage, shipping, or other purposes.

FIG. 32 is a perspective of embodiment 202 which is similar to embodiment 170 except upper translucent sidewalls 194 in embodiment 170 have been replaced by upper translucent sidewalls 204 in embodiment 202. Upper translucent sidewalls 204 are extended downward to match the downward excursion of appendage 206. This at least allows lid assembly 208; comprising control utility box 210, and shiny heat reflector 212 (FIGS. 36 and 37), to be positioned on a horizontal surface without rocking, as shown in FIG. 37, and to modularly stack, as shown in FIG. 33.

FIG. 33 is a perspective of embodiment 202 with two extension rings 214 modularly stacked on top of one another to provide an extended cooking cavity.

FIG. 34 is a perspective of embodiment 202 with upper translucent sidewalls 204 resting directly on base 216 without using extension rings 214.

FIG. 35 is identical to FIG. 34 except extension ring 214 is inverted and telescoped over upper translucent sidewall 204 for storage or other purposes.

FIG. 36 is a perspective showing lid assembly 208 removed from extension ring 214, and lid assembly 208 resting on one side. Protruding phalange 218 circumnavigating the bottom of upper translucent sidewalls 204 prevent the surfaces of upper translucent sidewalls 204 from being scratched when resting on a flat surface. Such a protrusion could be replaced by other outward projections, such as by way of non-limiting and non-exhaustive examples, protruding: pegs, domes, straight rails, etc. to perform the same function.

FIG. 37 is a perspective similar to FIG. 36 except instead of lid assembly 208 resting on a side, lid assembly 208 is placed upright on a supporting surface. As shown in FIGS. 38 and 39, safety interlock switch 222 helps prevent damage to countertops in this condition. Simply lifting lid assembly 208 and dropping onto a countertop may make embodiment use easier than having to place lid assembly 208 on its side, as shown in FIG. 36.

FIG. 38 is a perspective taken from the rear of embodiment 202.

FIG. 39 is an enlarged portion of FIG. 38, as indicated in FIG. 38.

FIG. 40 is a perspective of embodiment 224, which includes horizontal rotating turntable 226.

FIG. 41 is an enlarged portion of FIG. 40, as indicated in FIG. 40.

FIG. 42 is an exploded perspective of embodiment 224.

### DETAILED DESCRIPTION

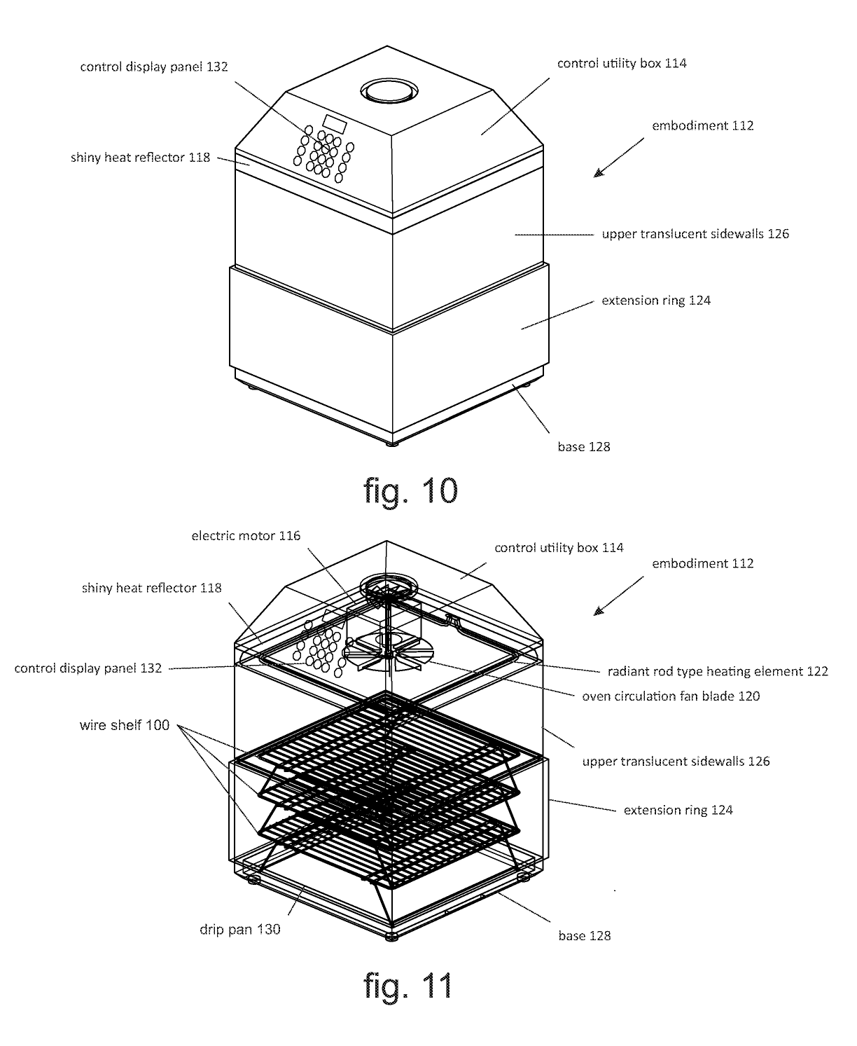

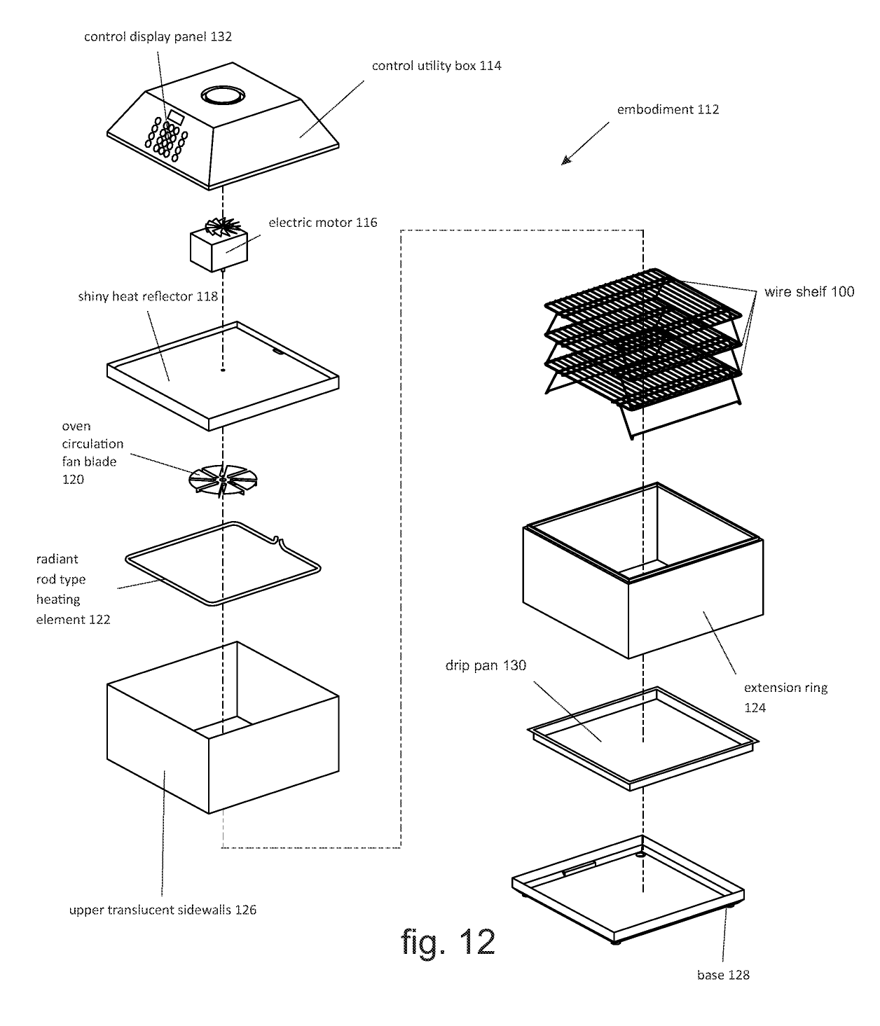

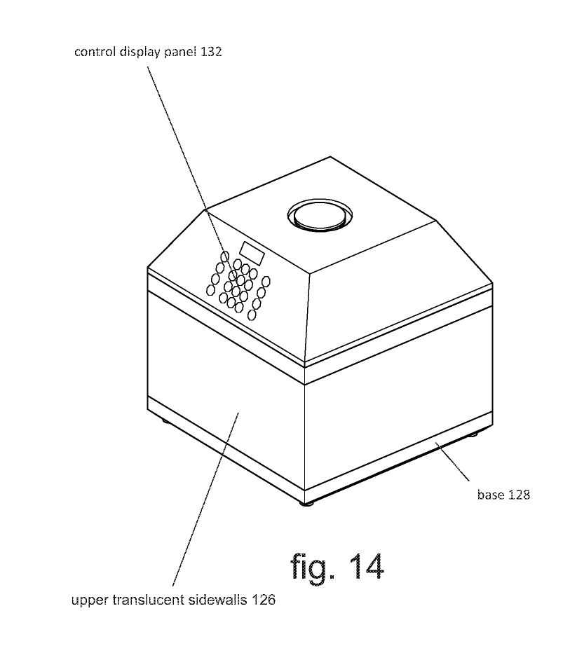

Referring to FIGS. 10, 11 and 12 specifically, as well as other figures and descriptions herein generally, embodiment 112 is comprised of:
control utility box 114, including electric motor 116, shiny heat reflector 118, motor driven oven circulation fan blade 120, and radiant rod type heating element 122.
Control utility box 114 removably drop mounts onto upper translucent sidewalls 126. It may also latch fixedly in this dropped relationship.
Upper translucent sidewalls 126 removably drop mounts onto either base 128, as shown in FIG. 14, or removably drop mounts onto extension ring 124, as shown in FIGS. 10 and 11.
If upper translucent sidewalls 126, is drop mounted onto extension ring 124 (FIGS. 10 and 11), extension ring 124 removably drop mounts onto base 128, where it also may be latched.
Drip pan 130 removably mounts within base 128 (FIGS. 11 and 12).
Zero or more wire shelves 100, at user discretion, may mount within upper translucent sidewalls 126 and/or within extension ring 134 (FIGS. 11 and 12). Extension ring 134 may be translucent, similar to upper translucent sidewall 126, or it may be opaque, as a non-limiting non-exhaustive example, it may be fabricated from metal. Likewise, upper translucent sidewalls 126 may be, as non-limiting and non-exhaustive examples, opaque or translucent.

Although not illustrated, embodiment 112 may be cylindrical, extruded elliptical or irregular curves, or extruded polygonal, such as, as non-limiting and non-exhausted examples, vertically extruded hexagons or octagons or regular or irregular polygonals, or other suitable shapes, instead of box shaped.

In operation, as a non-limiting and non-exhaustive example, a user places drip pan 130 within base 128, and then places one or more wire shelves 100 filled with food into drip pan 130 (FIGS. 11 and 12 in particular).

The user then mounts either extension ring 124, including upper translucent sidewalls 126, or simply upper translucent sidewalls 126 only, either including control utility box 114; onto base 128, by lowering either onto base 128. The user then inputs into control display panel 132, the desired cooking parameters, such as cooking temperature and time.

If browning is desirable on both sides of the food being cooked, such as cooking a cut of meat, or a fowl, or fish; the food may be partially rotated to various angles, or may be fully flipped one or more times during the cooking cycle.

After cooking is complete, the user then removes and serves the food.

In the event the user is cooking an irregular shaped food, such as, as non-limiting and non-exhaustive examples, a turkey, chicken, leg of lamb, etc., the user may fold back support leg 102 as shown in FIGS. 3, 7, and 15, to incline wire platform 104, so that the outer surfaces of the food may cook more evenly. The inclined platform along with the food 134 and any other underlying support wire shelves 100 is then placed into drip pan 130.

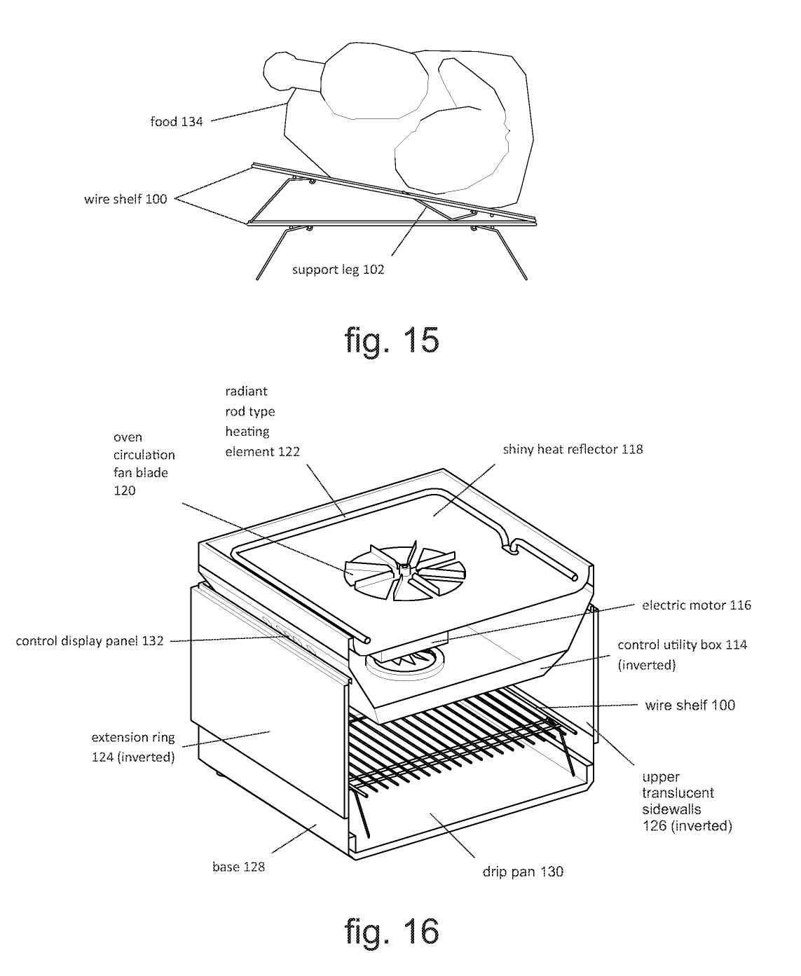

Food may be positioned vertically by placing one or more horizontally disposed raised shelves below an inclined shelf, such as shown in FIG. 15.

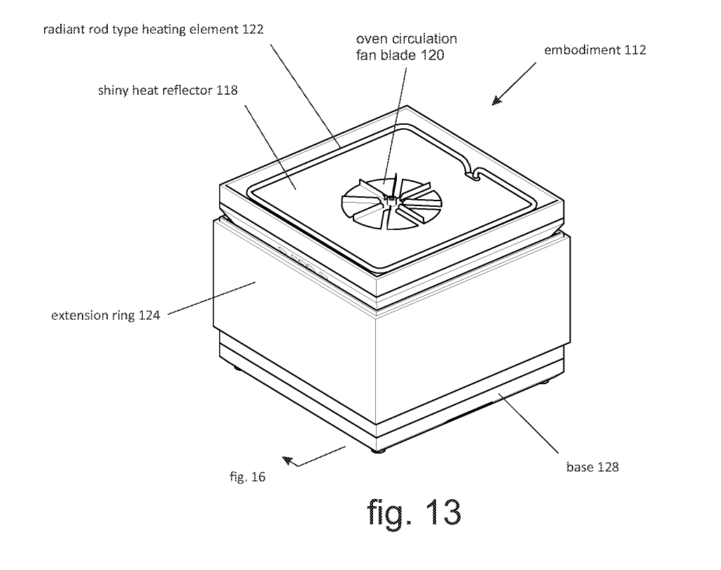

FIGS. 13 and 16 show how embodiment 112 may be compacted for storage, or other purposes, by inverting and telescoping extension ring 124 over upper translucent sidewalls 126, and then inverting and telescoping control utility box 114 into upper translucent sidewalls 126.

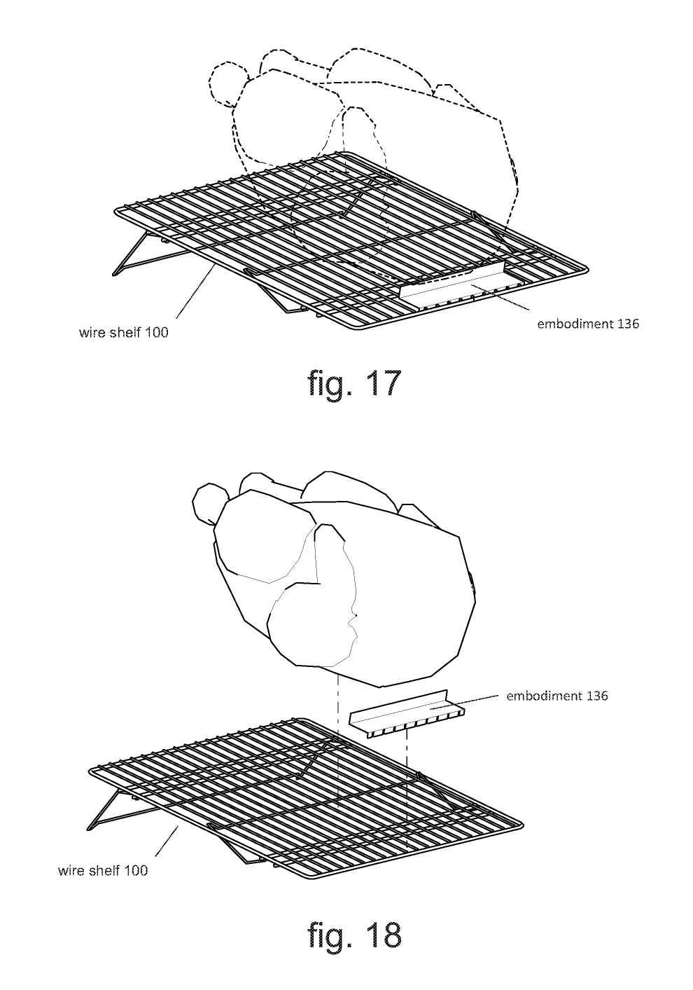

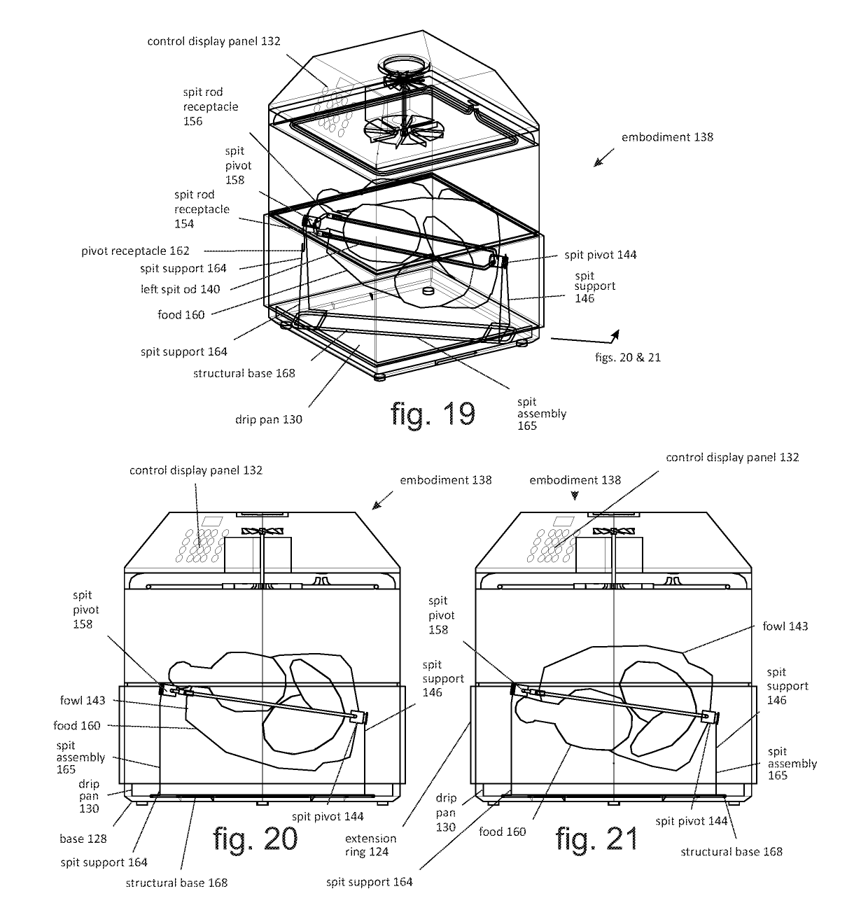

FIGS. 17 and 18 show embodiment 136 which is a removable stop to prevent foods from sliding down wire shelf 100 at least when wire shelf 100 is inclined (FIGS. 3, 7, 15, 17, and 18). Alternatively, embodiment 136 may be mounted at other locations on wire shelf 100, such as, as non-limiting and non-exhaustive examples, higher or lower on shelf 100 or further left or further right on shelf 100. Also as non-limiting and non-exhaustive examples, embodiment 136 may be permanently attached to wire shelf 100 and/or be constructed as part of wire shelf 100, and/or may be fabricated by molding, and or wire bending, and/or by other suitable means. Also, embodiment 136 may be proportioned to provide a stop higher on the inclined shelf 100 shown in FIGS. 17 and 18.

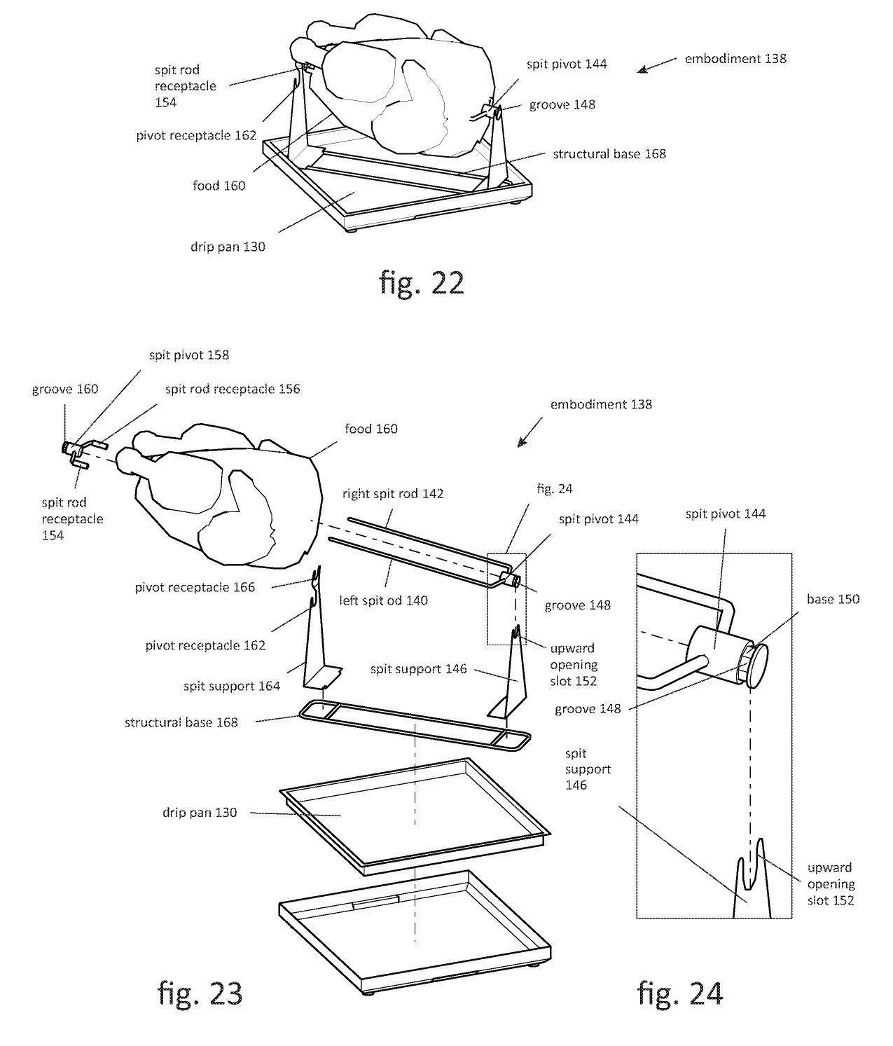

FIGS. 19 through 24 show embodiment 138, which is a hand powered spit food mounting system. Referring especially to FIGS. 23 and 24, embodiment 138 is comprised of: left spit rod 140, right spit rod 142, both of which are fixedly attached to spit pivot 144 which rotates within upward opening slot 152 in spit support 146. As seen best in FIG. 24, spit pivot 144 has groove 148, which at its base 150 (FIG. 24) is octagonal in cross-section.

Groove 148 lowers into, and rotates within, upward opening slot 152 which is disposed on the upward portion of spit support 146 (FIG. 24 especially). The bottom of upward opening slot 152 is a ½ octagon, close to the same diameter as base 150, with four generally equilateral sides on its bottom. Thus, when spit pivot 144 rotates within upward opening slot 152, it has tactile stops every 45° of rotation, which helps in the precise radial positioning of foods mounted on left spit rod 140 and right spit rod 142.

Spit rods 140 and 142 on the side opposite spit pivot 144, removably, slidably, and telescopically engage spit rod receptacles 154 and 156 respectively (FIGS. 19 and 23), which are generally tubes fixedly attached to spit pivot 158 (FIG. 23). Spit pivot 158 includes groove 160, which has an external configuration which is generally a mirror image of groove 148. Thus the entire spit assembly can be used with either spit pivot 144 or spit pivot 158 engaging spit support 146.

In use, as a non-limiting and non-exhaustive example, a user skewers food 160 roughly through its lateral horizontal center using both left spit rod 140 and right spit rod 142.

Alternatively, the user may skewer one or more food articles onto one and/or both of left spit rod 140 and spit rod 142.

The user then slides groove 148 or groove 160 into upward opening slot 152 in spit support 146 (FIG. 24).

Whichever groove (146 or 160) was chosen to slide into upward opening slot 152, the other groove is then slid into pivot receptacle 162 or pivot receptacle 166 in spit support 164. If the user chose to slide whichever groove into pivot receptacle 166, the spit assembly is then inclined, as shown in FIGS. 19, 20, 21, and 22. This inclined disposition may cook irregular foods, such as fowl and leg of lamb, which are somewhat conical in outer form, more evenly under the overhead radiant heat source (see FIGS. 19, 20, and 21).

If user chose to slide whichever groove into pivot receptacle 162, the pivot assembly is then disposed generally horizontally.

Structural base 168 is disposed within drip pan 130, which in turn is disposed within base 128, which in turn supports extension ring 124 (FIGS. 19, 20, 21, 22, and 23). An assembly comprising upper translucent sidewalls 126 supporting control box 114 is then lowered onto and couples with the upper rim of extension ring 124.

The user then sets the cooking time and temperature using control display panel 132, and allows cooking to take place for a predetermined amount of time. During this time, the food may be rotated one or more times by hand, at user determined angles, to help even out the radiant and hot air movement cooking. After cooking, the food is dismounted from left spit rod 140 and right spit rod 142, and served.

Alternatively, food 160 may be left mounted on left spit rod 140 and right spit lot 142, and the entire spit assembly 165, including food 160, may be removed from drip pan 130, and used on a table for carving and/or serving stand.

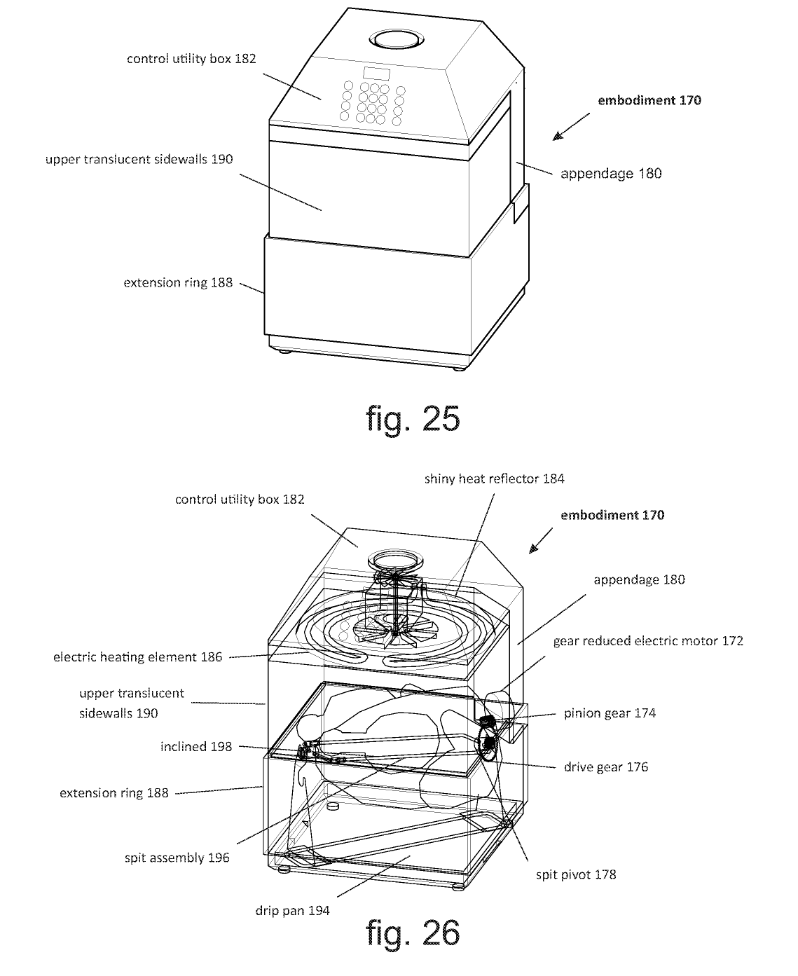

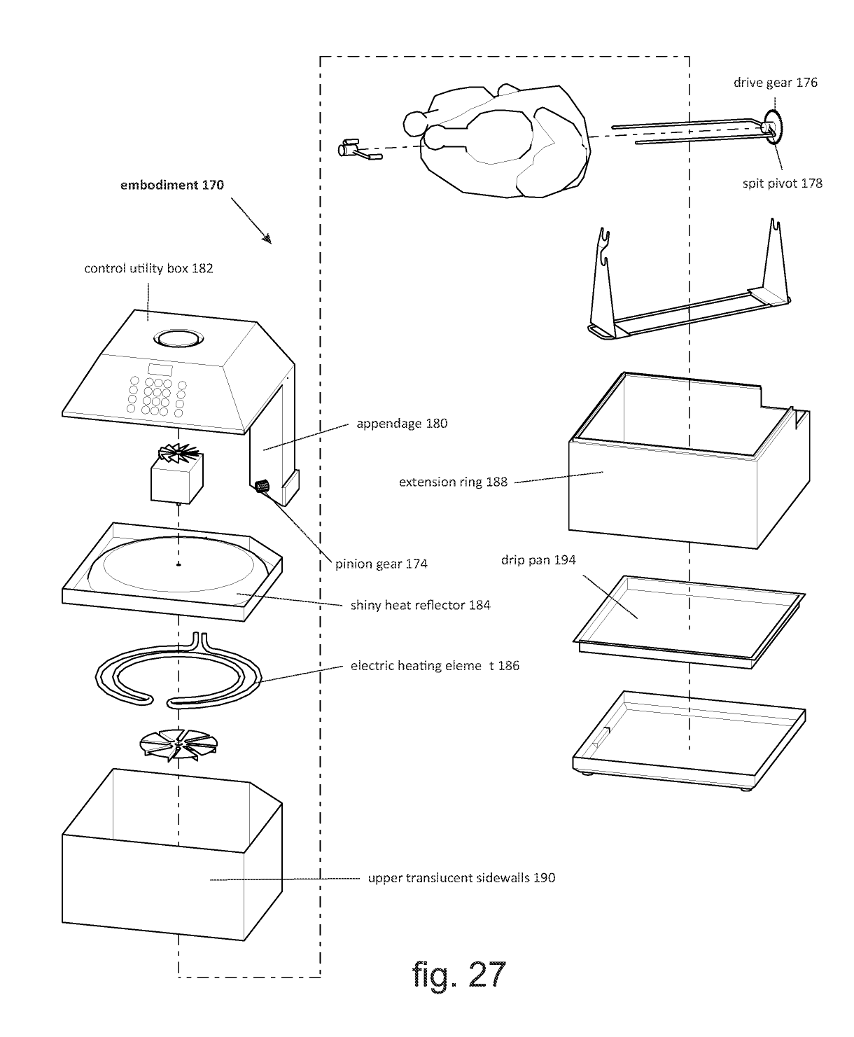

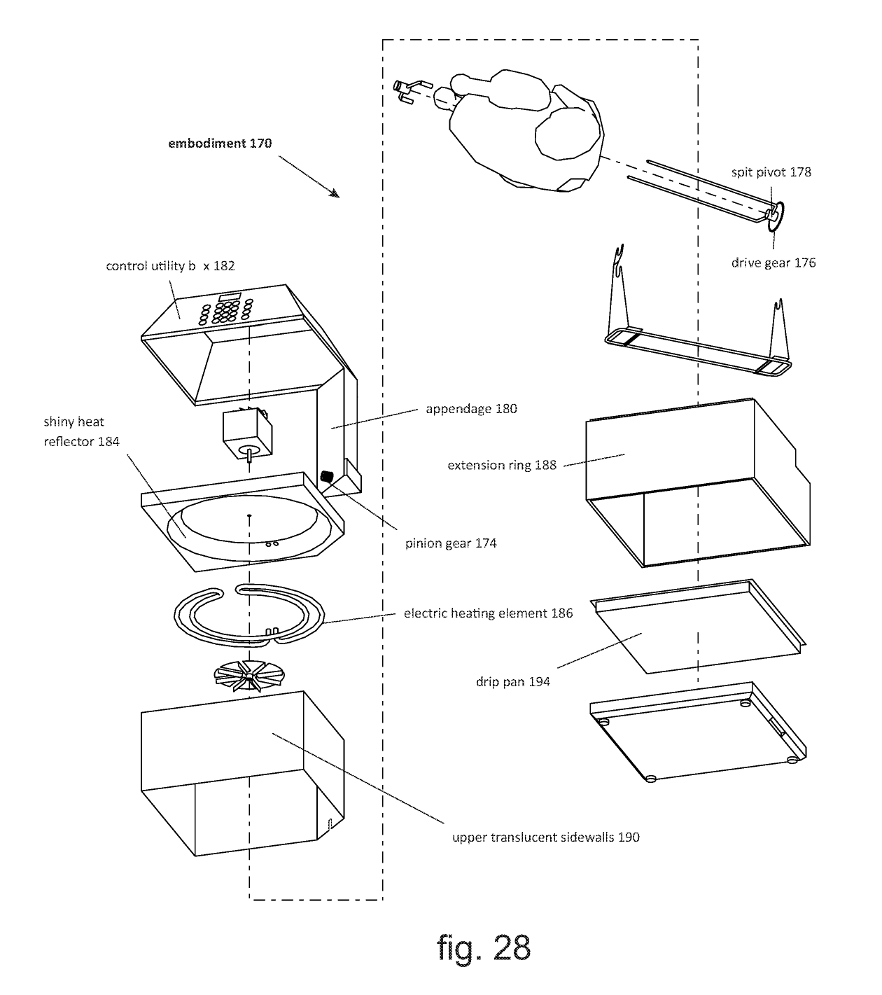

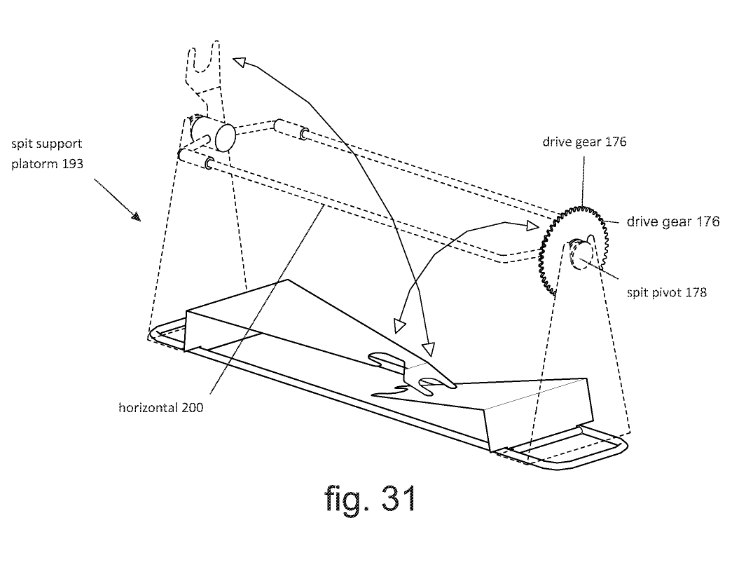

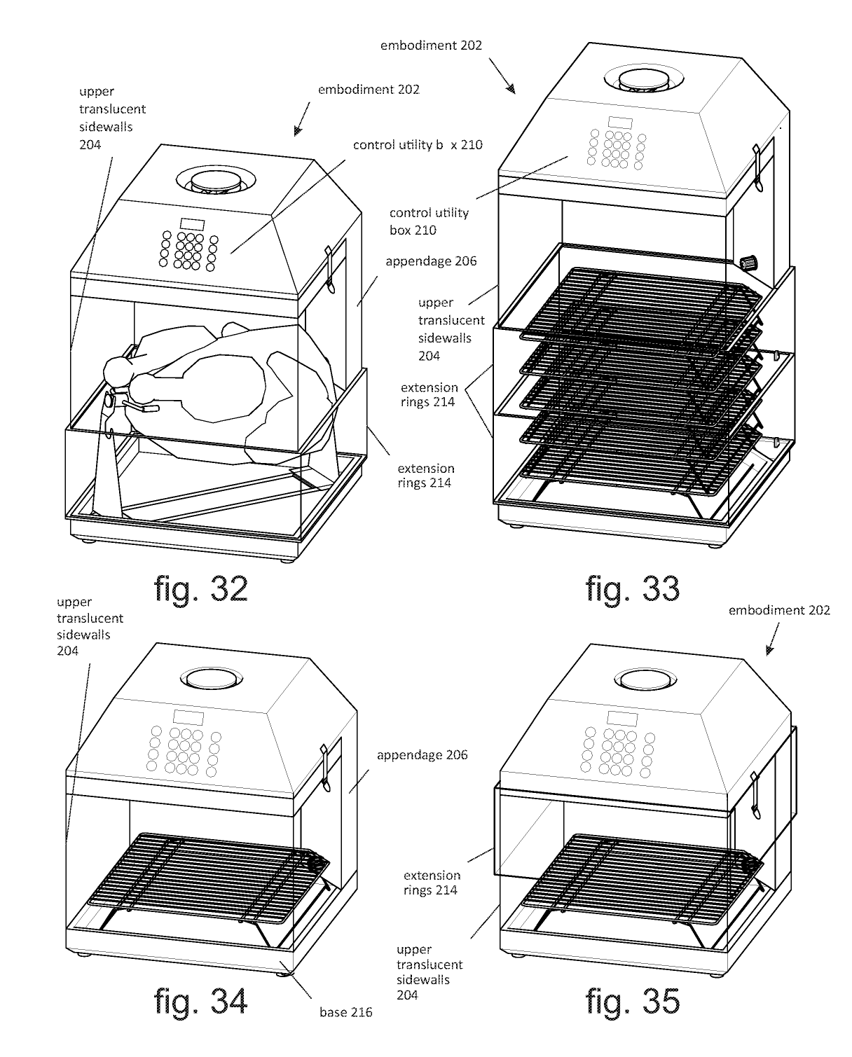

FIGS. 25 through 30 show embodiment 170 which is similar to embodiment 138 except spit assembly 196 is powered by a gear reduced electric motor 172 through motor shaft attached pinion gear 174, which detachably engages drive gear 176, which is fixedly attached to spit pivot 178 (FIGS. 26, 27, 28, 29, and 31). This replaces the need for hand rotation of spit assembly 196 and the food mounted on it, as shown in embodiment 138. No octagons are used in the spit pivot grooves during power rotation.

Hand rotation and positioning of spit assembly 196 and the food mounted on it, whether the spit rods are in an inclined 198 or horizontal 200 disposition, is still an option by rotating spit assembly 196 90° about a vertical central drip pan 198 axis. This prevents pinion gear 174 from engaging drive gear 176, and allows hand rotation for precise food positioning.

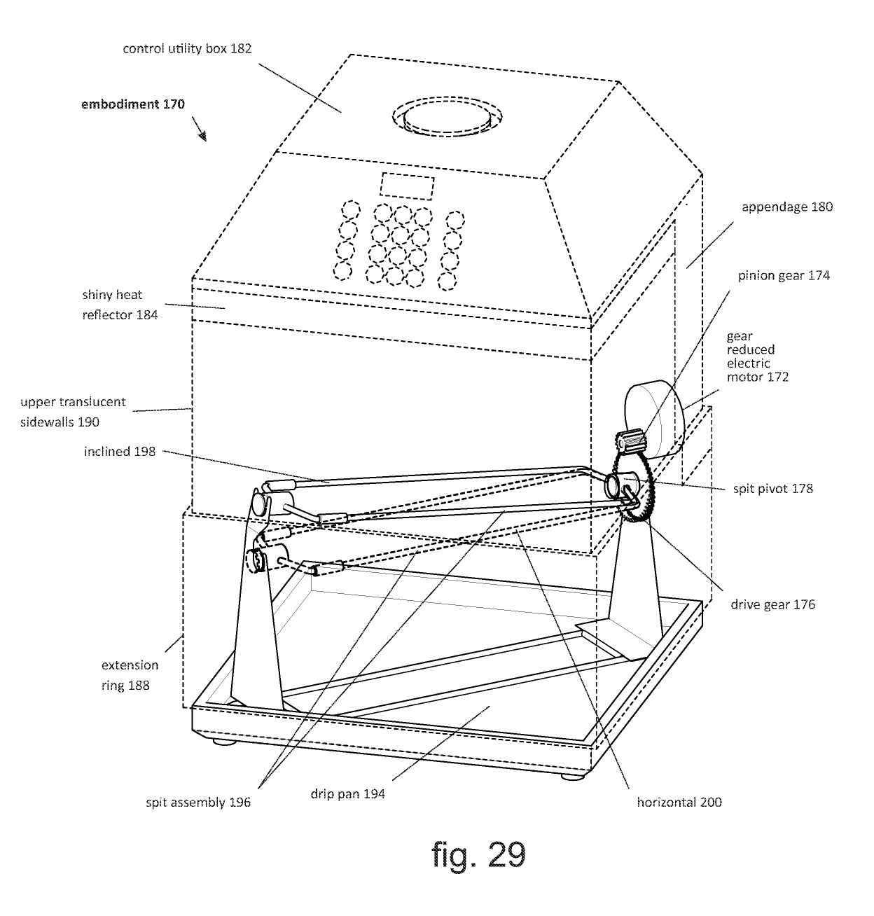

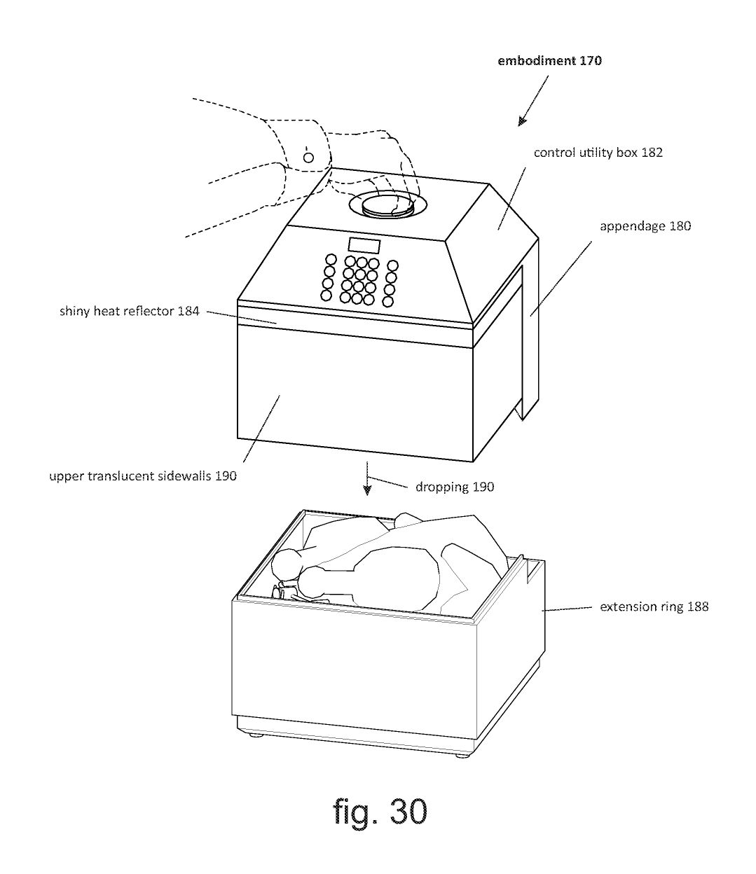

Gear reduced electric motor 172 is mounted within appendage 180 of control utility box 182 (FIGS. 26 and 29). Dropping 190 (FIG. 30) the assembly comprising control utility box 182, including shiny heat reflector 184, and resistive rod electric heating element 186, and gear reduced electric motor 172, motor driven fan 192 and upper translucent sidewalls 190; onto extension ring 188 (see FIG. 30), causes pinion gear 174 to engage drive gear 176, regardless of whether the spit assembly is disposed inclined 198 (solid lines) or horizontally 200 (dotted lines) (see FIG. 29).

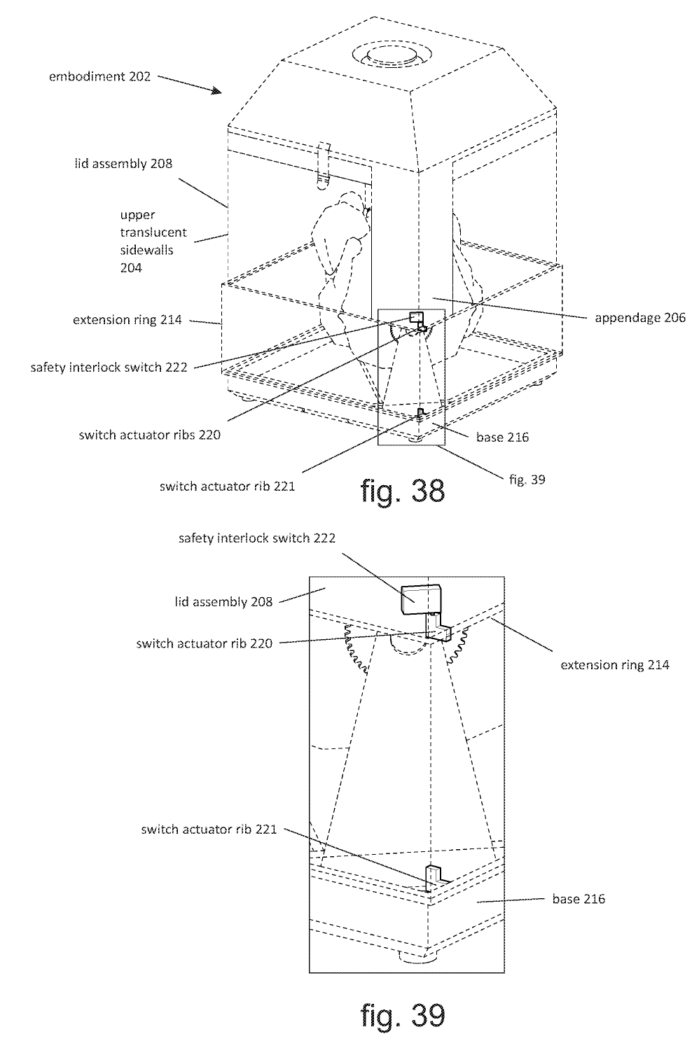

FIGS. 38 and FIG. 39 show embodiment 202 most of which is ghosted out in dotted lines, except for safety interlock switch 222, and switch actuator ribs 220 and 221. Switch actuation rib 220 is fixedly attached to extension ring 214 near the top of extension ring 214, and switch actuation rib 221 is fixedly attached to base 216, near the top of base 216. Safety interlock switch 222 is fixedly attached to, and is disposed within, appendage 206, as shown in FIG. 38.

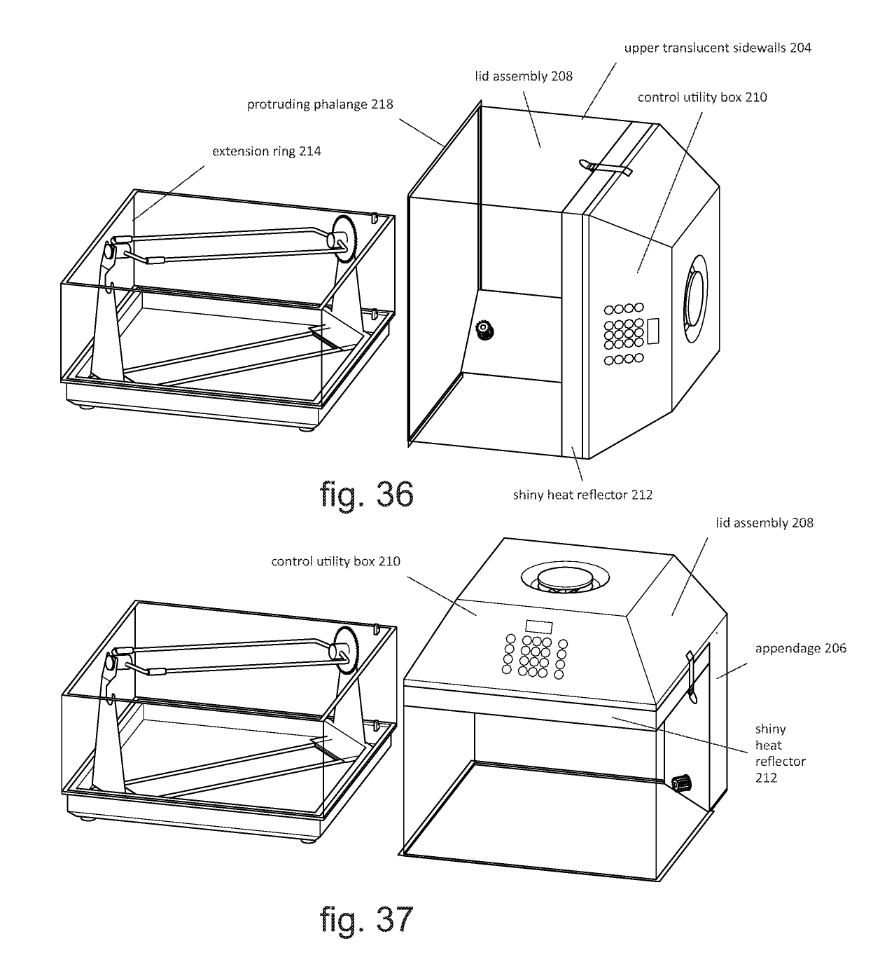

Either of switch actuation ribs 220 and 221, by pressing against the actuation lever on safety interlock switch 222 (FIGS. 38 and 39), turns on the operation of embodiment 202 when lid assembly 208 is placed on top of either extension ring 214 or base 216. This is a safety feature which may help prevent scorched countertops and the risk of fire, especially, but not limited to, when lid assembly 208 is rested in an upright position on a flat support surface, such as shown in FIG. 37.

As an alternative to either switch actuation rib 221 or switch actuation rib 220 pressing directly against the actuation lever of safety interlock switch 222, an intermediate rod linking the either actuation rib (221 or 220) to the actuation lever might be used. As a non-limiting and non-exhaustive example, such a rod might be mounted in a vertical slidable manner between either switch actuation rib 221 or switch actuation rib 220, and the switch 222 actuation lever. This could be done on any of the vertical sidewalls of upper translucent sidewalls 204, or at any other suitable location. Such a structure would allow mounting safety switch 222 within control utility box 210, or at any other suitable location away from actuation ribs 224 or 221. This may make manufacture simpler.

As another alternative, safety interlock switch 222, instead of being mechanically actuated, might be magnetically triggered. In this example alternative, either of switch actuation ribs 220 and 221 would be replaced with a magnet, which, when placed in proximity to a magnetic version of switch 222, would turn on the device. Such a construction might be extremely durable and long-lived.

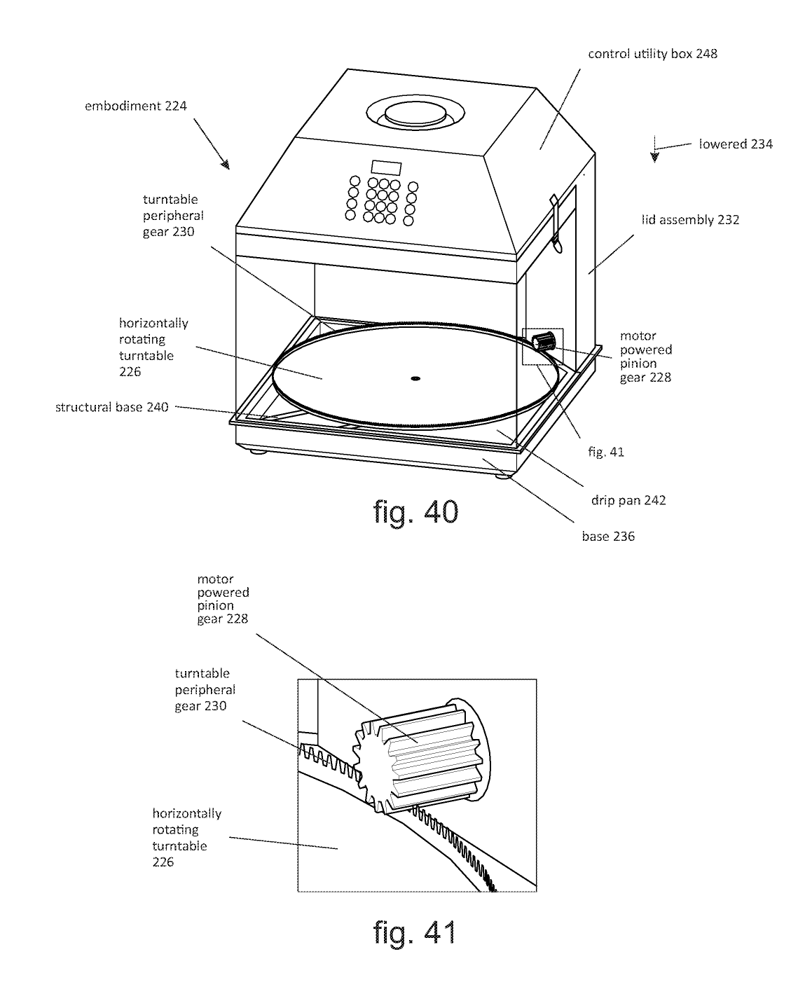

FIGS. 40, 41, and 42 show embodiment 224, comprising horizontally rotating turntable 226 rotated by motor powered pinion gear 228 which engages turntable peripheral gear 230 when lid assembly 232 is lowered 234 onto base 236. This structure and function are similar to that of pinion gear 174 being energized by geared electric motor 172 engaging drive gear 176 when control utility box 182 is lowered 190 onto extension ring 188 in FIGS. 29 and 30.

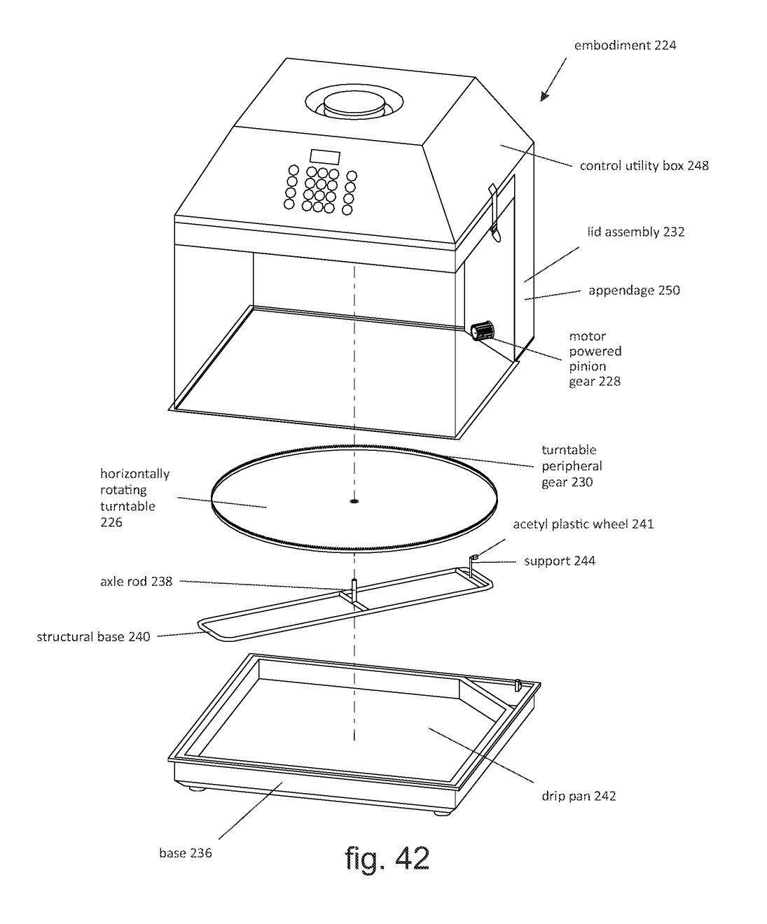

Turntable 226 as a centrally mounted tube shaped member on its underside and rotates on top of, and is telescopically connected to, axle rod 238 (FIG. 42), which provides a central rotational axis.

Structural base 240 also mounts support 244 which aligns turntable 226 vertically to positively engage turntable peripheral gear 230 with pinion gear 228. Support 244 is capped on its upper portion by a rotating or fixed low-friction member, such as acetyl plastic wheel 241 (FIG. 42). Structural base 240 also removably and fixedly mounts within, and on top of the floor of, drip pan 242.

Horizontal rotating turntable 226 floor may have a solid sheet floor as illustrated, or may be of perforated sheet design, or may be screen or wire mesh, or may be of other suitable construction.

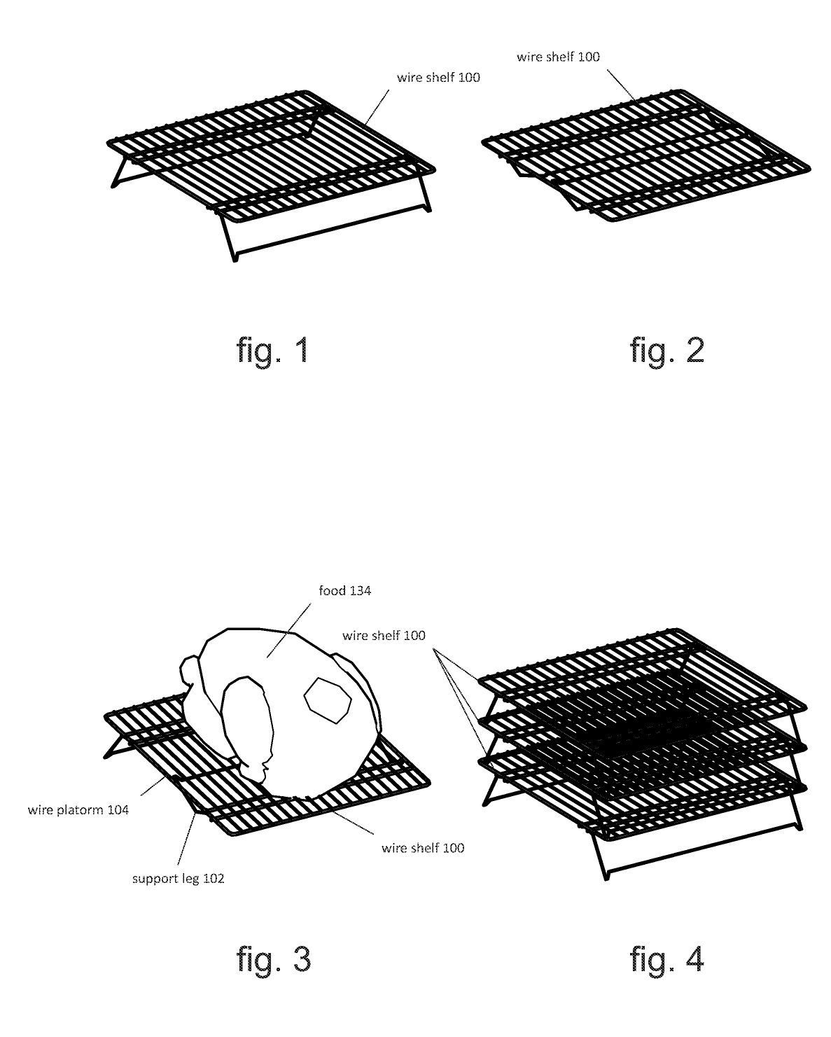

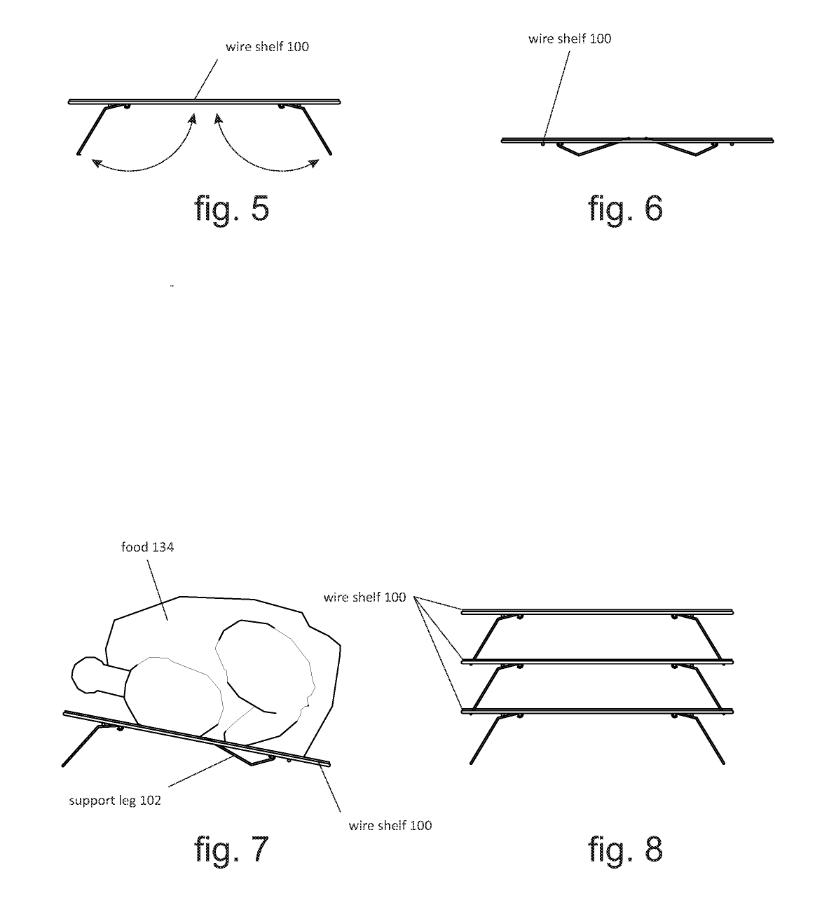

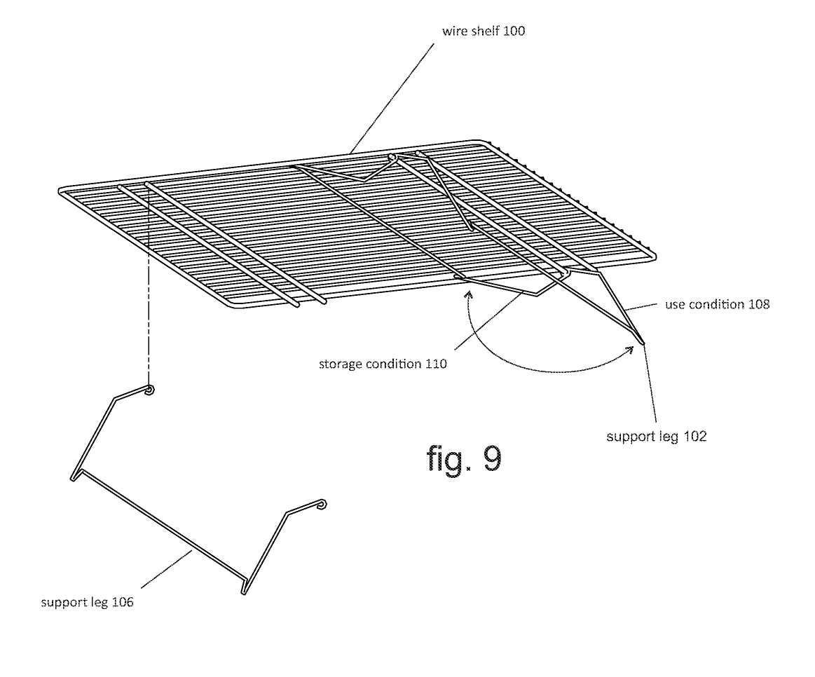

In operation, as a non-limiting and non-exhaustive example, a user might place food directly on top of turntable 226; or might place food mounted on a horizontal or inclined shelf, such as wire shelf 100 (FIGS. 1 through 9), or might place food mounted on a manual spit such as embodiment 138; any of which would then rested on top of turntable 226.

Lid assembly 232; including control utility box 248, appendage 250, and motor powered pinion gear 228; is then lowered 234 (FIG. 40) onto base 236 which contains turntable 226 mounted onto structural base 240. Lowering lid assembly 232 onto base 236, results in pinion gear 228 engaging turntable peripheral gear 230, and turntable 226 being thus motor driven.

Using control utility box 248, the user then sets the cooking parameters such as time and temperature and cooks, and afterwards, serves the food.

The horizontal rotation provided by turntable 226 at least may help foods cook more evenly.

After removing turntable 226 and structural base 240 from drip pan 242, embodiment 224 might also mount a motor powered spit assembly such as shown for embodiment 170 (FIGS. 26, 27, 28, 29, and 31).

1. A food support system for cooking unitary tapered foods including chickens, turkeys or leg of lamb, the food support system comprising:
a radiant heat source,
a food support platform including a generally planar food support surface, wherein the platform is disposed below the radiant heat source,
a first platform support coupled to a first side of the food support platform and configured, in a first configuration, to support the first side of the food support platform in a first elevated disposition, and the first platform support configured, in a second configuration, to support the first side in a disposition which is lower than the first configuration,
a second platform support coupled on an opposite side of the food support platform from the first platform support, the second platform support, in a third configuration wherein the opposite side of the food support platform is raised to a height generally the same as the first elevated disposition.

2. The food support system of claim 1 wherein the food support platform is configured to be modified from the first configuration to the second configuration while the second platform support is in the third configuration so as to support an upper portion of a tapered article of food, such as a fowl or leg of lamb, to provide more even exposure to heat energy from heat emitted by the radiant heat source.

3. The food support system of claim 1 wherein the first platform elevating support is in the first configuration and the second platform elevating support is in its third configuration, wherein the food support platform is configured to stack on top of a second, substantially identical, food support platform, the second food support platform also disposed in corresponding first and third configurations.

4. The food support system of claim 1 wherein the first platform elevating support is in the second configuration and the second platform elevating support is in the third configuration, such that the food support platform is configured to stack on top of a second, substantially identical food support platform, the second food support platform being disposed in corresponding first and third configurations.

5. The food support system of claim 1 wherein the first platform elevating support is in the second configuration and the second platform elevating support is in a fourth configuration wherein the opposite end is lowered to a height less than that of the third configuration such that the food support platform defines a lessened outer volume relative to the first elevating support disposed in the first configuration and the second platform elevating support disposed in third configuration.

6. The food support system of claim 1 further including a protruding member projecting above the upward facing, generally planner food support surface, and wherein the first platform support is in the second configuration and the second platform support is in the third configuration such that the planer food support surface is inclined, and wherein the protruding member is configured to impede food movement down the inclined generally planner food support surface.

7. The food support system of claim 6, further including that the protruding member is configured to be manually removable from the generally planner food support surface.

8. The food support system of claim 1, further including a cooking chamber housing the radiant heat source and the food support platform, and wherein the cooking chamber includes a fan configured move hot air within the cooking chamber.

9. A cooking oven comprised of an upper portion and a lower portion, and the upper portion configured to rest in an upright position on the lower portion so as form a cooking chamber,
the upper portion including user input controls configured to regulate temperature in the cooking chamber,
the lower portion including generally vertical sidewalls and a floor, lower portion configured to surround the user input controls when the upper portion is inverted and placed into the lower portion, and while so disposed, occupy less volume than when portion rests on the lower portion with the upper portion in an upright position.

10. The cooking oven of claim 9 further including an extending sidewall configured to be disposed intermediate of the upper portion and the lower portion so as to increase the volume of the cooking chamber.

11. The cooking oven of claim 10 wherein the extending sidewall are configured to, when inverted, telescope over and surround the lower portion when the lower portion surrounds the user input controls.

12. A food support system for mounting a unitary tapered article of food, such as a fowl or leg of lamb, comprising:
a heat source configured to heat associated food being cooked to cooking temperatures,
a spit rod having a first end and a second end, and configured to penetrate through an associated unitary article of food being cooked,
a first spit support, having a first mount to couple to the first end of the spit rod and an opposing second spit support, having a second mount configured to couple to the second end of the spit rod, and wherein
the first mount is configured above the second mount so as to incline the spit rod when the spit rod is mounted intermediate of the first and second mounts.

13. The food support system of claim 12 wherein the spit rod is configured for manual rotation.

14. The food support system of claim 13 wherein the spit rod is further configured for non-continuous manual rotation.

15. The food support system of claim 12 wherein the spit rod is further configured for rotation by an electric motor.

16. The food support system of claim 15 further including a cooking chamber comprised of a lower portion and a detachable upper portion, the upper portion including a motor energized first gear, and the lower portion mounting the first and second spit supports, the spit rod mounted intermediate of the first and second spit supports and the spit rod fixedly coupled to a second gear which is configured to rotate the spit rod when engaged to a rotational power source, and the motor energized first gear engages the second gear when the upper portion of the cooking chamber is lowered onto the lower portion of the cooking chamber.

17. The food support system of claim 16, further including a rotatable turntable having a peripheral gear engaging the first gear when the upper portion is lowered onto the lower portion.

18. The food support system of claim 16, further including the first and second spit supports configured to be manually removable from the lower portion.

19. The food support system of claim 12, further including the first spit support having a third mount which generally equal in height to the second mount on the second spit support, wherein when the spit rod is disposed horizontally when mounted between the second and third mounts.

20. The food support system of claim 12 further including a second spit rod disposed parallel to the first spit rod wherein the second spit rod is configured to mount a unitary article of food cooperatively with the first spit rod.

21. The food support system of claim 12 further including a structural base configured to mount both the first and second spit supports in generally vertical dispositions, and further configured to selectively mount both the first and second spit supports in generally horizontal dispositions for more compact storage.

22. A safety cook oven comprising:
a cooking chamber formed by an upper portion joined to a lower portion,
the upper portion including a control box configured to regulate cooking temperature, and a heat source configured to heat associated foods being cooked within the cooking chamber to cooking temperatures,
the upper portion including a transparent, downward projecting vertical wall, which surrounds half of the upper portion,
an appendage projecting downward from the control box along the vertical wall at an intersection of the upper and lower portions,
the appendage configured to house a switch to selectively provide power to activate or deactivate the heat source,
the lower portion including a projecting member configured to activate the switch when the lower portion is joined to the upper portion.

23. The cook oven of claim 22 further including a generally vertical extending annular sidewall configured to be disposed intermediate of the upper and lower portions so as to increase cooking chamber volume, the extending annular sidewall having a projecting member configured to activate the switch when the upper portion is lowered onto the extending annular sidewall.

24. A method for preparing fowl, comprising:
mounting a fowl on an inclined food support,
positioning the inclined food support and mounted fowl in a food preparation environment,
performing a food preparation process on the fowl,
removing the inclined food support and mounted fowl from the food preparation environment, and
dismounting the fowl from the inclined food support.

25. The method of claim 24, further comprising mounting the fowl the food support comprised of an inclined platform.

26. The method of claim 24, further comprising mounting the fowl the to the food support further comprising an inclined spit which penetrates the fowl lengthwise.

27. The method of claim 26, further comprising manually rotating the inclined food support.

28. The method of claim 26, further comprising powering on a motor to rotate the inclined food support.

29. The method of claim 24 wherein performing a food preparation process includes powering on a radiant heat source disposed above the inclined food support.

30. The method of claim 24 further comprising positioning the food support horizontally while the fowl is mounted on the inclined food support.
